(19) United States
(12) Patent Application Publication
(10) Pub. No.: US 2019/0251878 A1
(43) Pub. Date: Aug. 15, 2019

(54) SOLAR LIGHT YARD SIGN SYSTEM

(71) Applicant: Derick Rogers, Cedar Falls, IA (US)

(72) Inventor: Derick Rogers, Cedar Falls, IA (US)

(21) Appl. No.: 16/276,716

(22) Filed: Feb. 15, 2019

Related U.S. Application Data
(60) Provisional application No. 62/630,882, filed on Feb. 15, 2018.

(51) Int. Cl. G09F 13/04; F21S 9/03; G09F 7/18

(52) U.S. Cl. CPC G09F 13/0413; G09F 2013/0445; G09F 7/18; F21S 9/035

(57) ABSTRACT

A solar light yard sign system that is configured to display information and advertisements during daytime and nighttime hours as a result of utilizing solar lights to internally illuminate the display panels while the system is securely attached to the surface upon which the system sits.

### CROSS REFERENCE TO RELATED PATENT APPLICATIONS

This present utility patent application claims priority to U.S. Provisional Patent Application No. 62/630,882 entitled “Solar Light Yard Sign System” filed on Feb. 15, 2018, which is fully incorporated by reference herein.

### FIELD OF THE DISCLOSURE

This disclosure relates generally to a solar light yard sign system, more particularly, and without limitation, to a solar light yard sign system configured to display information and advertisements during daytime and nighttime hours as a result of utilizing solar lights to internally illuminate the display panels while the system is securely attached to the surface upon which the system sits.

### BACKGROUND OF THE DISCLOSURE

Yard sign systems are utilized by real estate brokers, building developers, and others whom desire to advertise or provide information to passers-by. For clarity, real estate brokers utilize yard sign systems in the yard of a real estate property which is for sale and there are many yard sign systems which may be utilized for this purpose. Thus, the use of a yard sign system to display information and advertisements to passers-by is well known in the prior art. One example of a yard sign system is disclosed in U.S. Pat. No. 4,885,860 which provides for a yard sign system which comprises a pan shaped configuration and is adapted to nest one panel to nest within the other which prevents the display panels from sliding down on the support frame. Another example of a yard sign system is disclosed in U.S. Pat. No. 5,937,555 which provides for laminated thermoplastic yard sign which prevents light transmission from one side through the other without the need of coextruded films.

While these yard sign systems fulfill their respective, particular objectives, they all suffer from their own disadvantages and limitations and therefore the need remains for a solar light yard sign system that, among other objectives, is configured to display information and advertisements during daytime and nighttime hours as a result of utilizing a light source, such as solar lights, to internally illuminate the display panels while the system is securely attached to the surface upon which the system sits.

For the reasons stated above, and for other reasons stated below which will become apparent to those skilled in the art upon reading and understanding the specification, there is a need in the art for an improved yard sign system.

### BRIEF SUMMARY OF THE DISCLOSURE

A solar light yard sign system that is configured to be positioned upon a surface or inserted into a surface, such as a yard, a lawn, a parking or curb area, or the like, and to be lit, when necessary, in order to provide information or advertising to passers-by during day time or night time hours. Alternatively, a solar light yard sign system that is configured to hang from a support where the system is connected to a mounting member, such as a string, a cord, or the like, and to be lit, when necessary, in order to provide information or advertising to passers-by during day time or night time hours.

### BRIEF DESCRIPTION OF THE DRAWINGS

FIG. 1 is an elevation view of the front of the solar light yard sign system; the view showing the solar light yard sign system having a frame, upper panels, and lower panels;

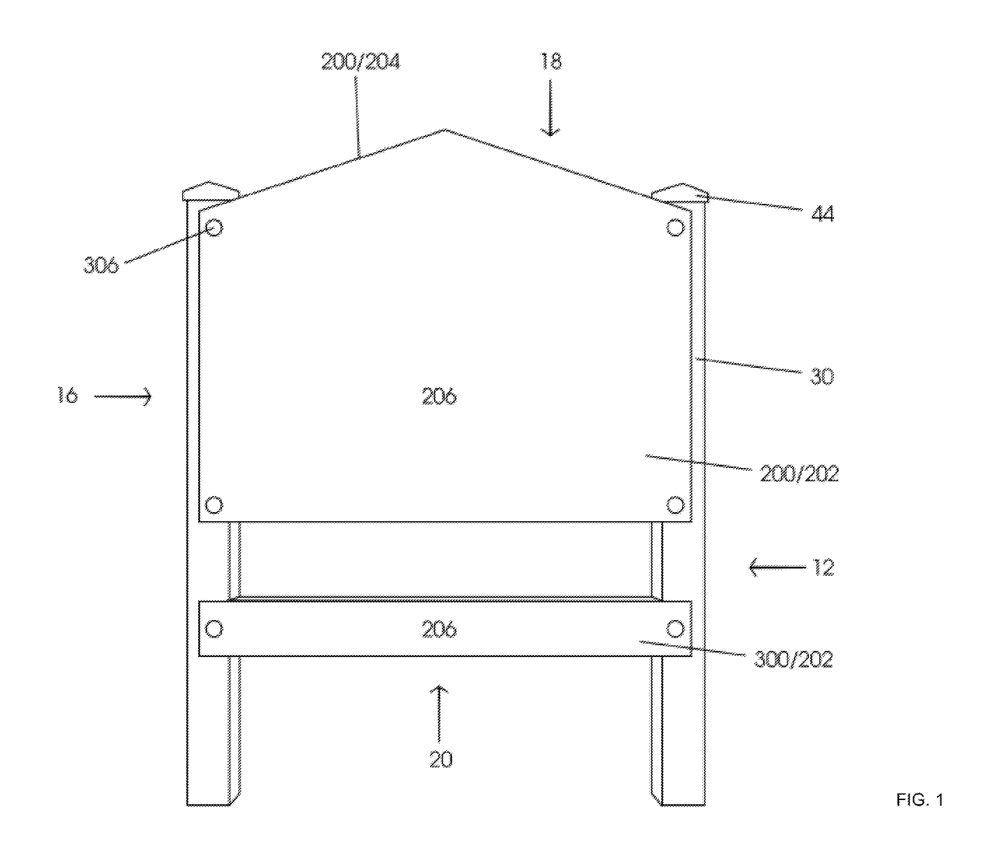

FIG. 2 is an elevation view of the front of the solar light yard sign system wherein the front upper panel has been removed to show the plurality of rods; the view showing the components contained between the upper panels;

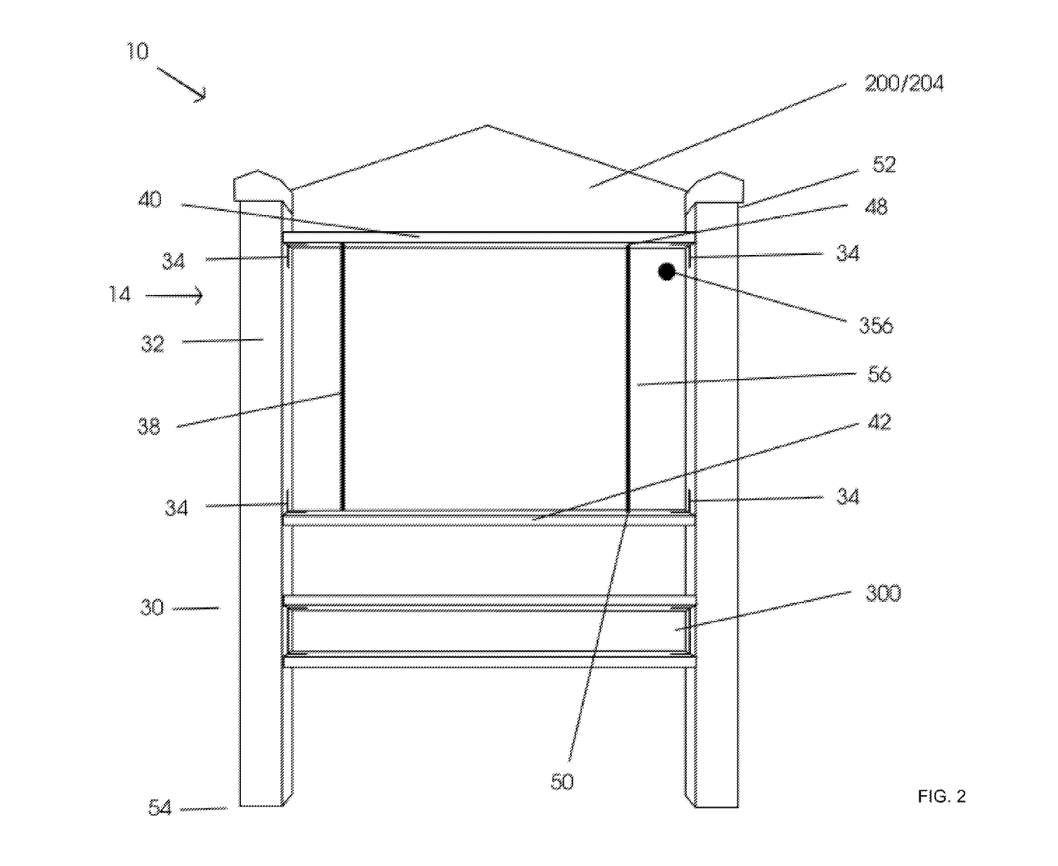

FIG. 3 is an elevation view of the top of the solar light yard sign system; the view showing the top perspective of the system wherein the power source is visible;

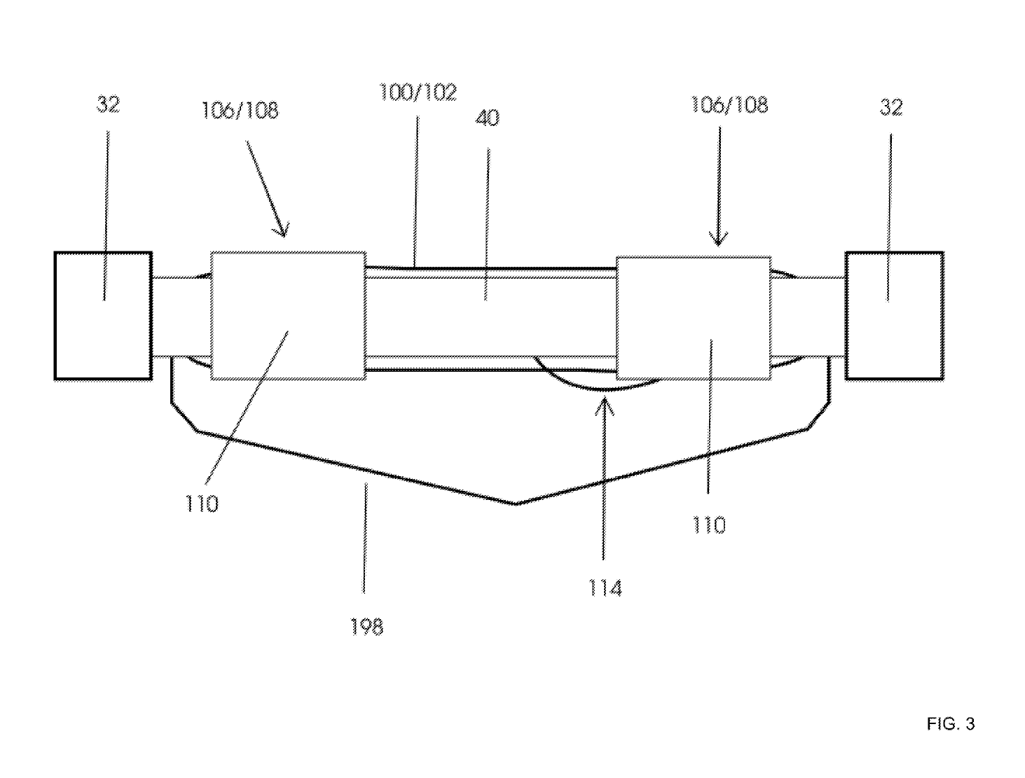

FIG. 4 is an elevation view of the front of the solar light yard sign system wherein the front upper panel has been removed; the view showing the plurality of rods and the light source being wrapped around the plurality of rods between the upper panels and another light source positioned between the lower panels;

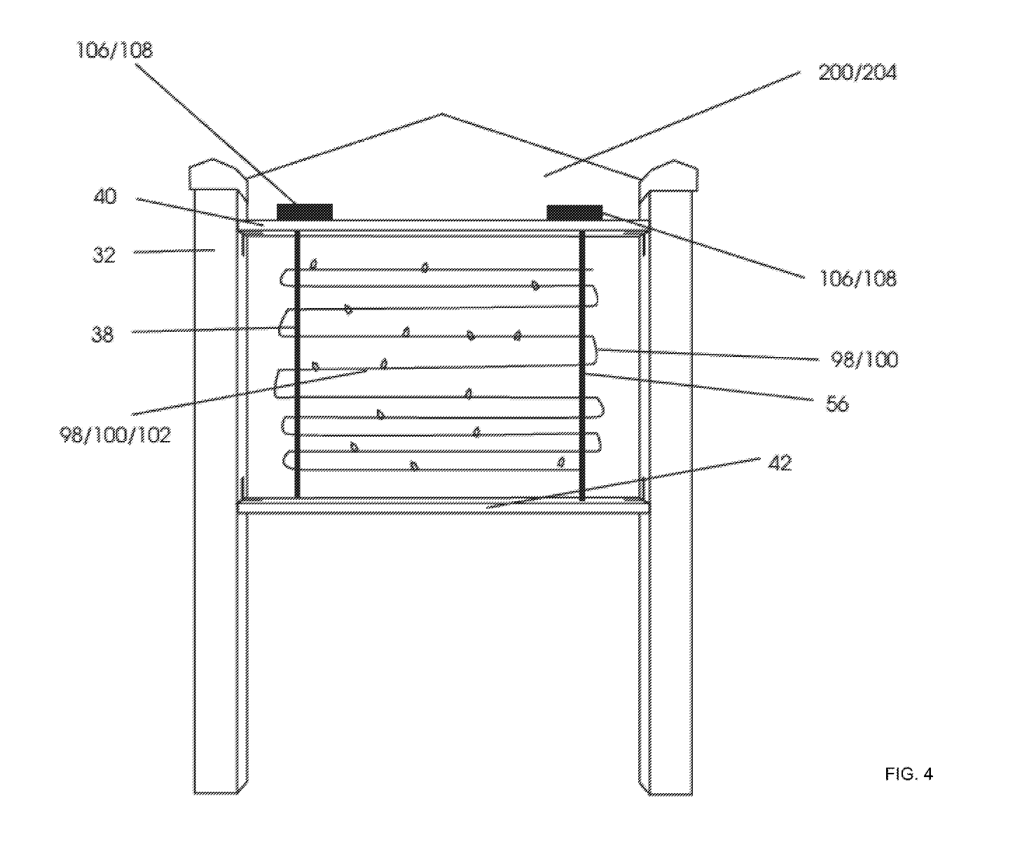

FIG. 5 is an elevation view of the front of the solar light yard sign system wherein the front upper panel has been removed; the view showing the plurality of rods and a light source being wrapped around the plurality of rods between the upper panels; the view also shows an alternative embodiment wherein the system does not comprise lower panels;

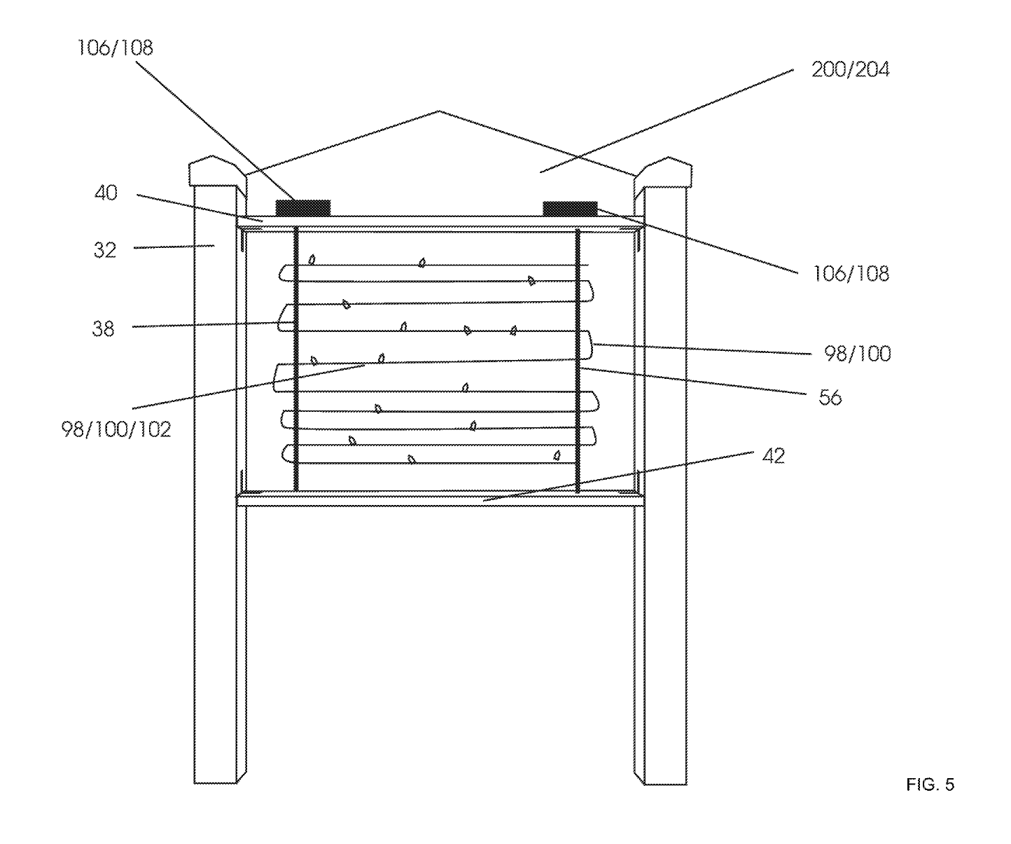

FIG. 6 is an elevation view of the front of the solar light yard sign system wherein the front upper panel and the front lower panel have been removed; the view showing an alternative embodiment of the light source being solitaire lights connected to the frame; the view also showing a solar panel;

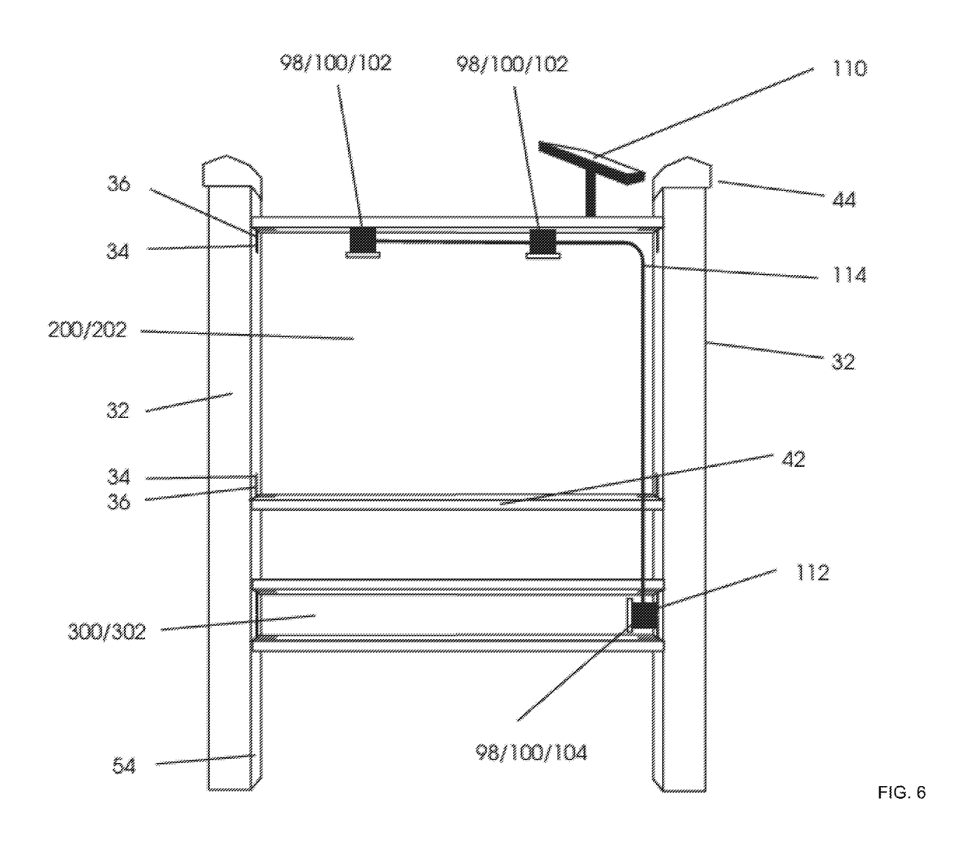

FIG. 7 is a perspective view of a plurality of rods positioned in a surface; the view showing the plurality of rods wherein the solar light yard sign system would connect to the plurality of rods in order to secure the solar light yard sign system to the surface;

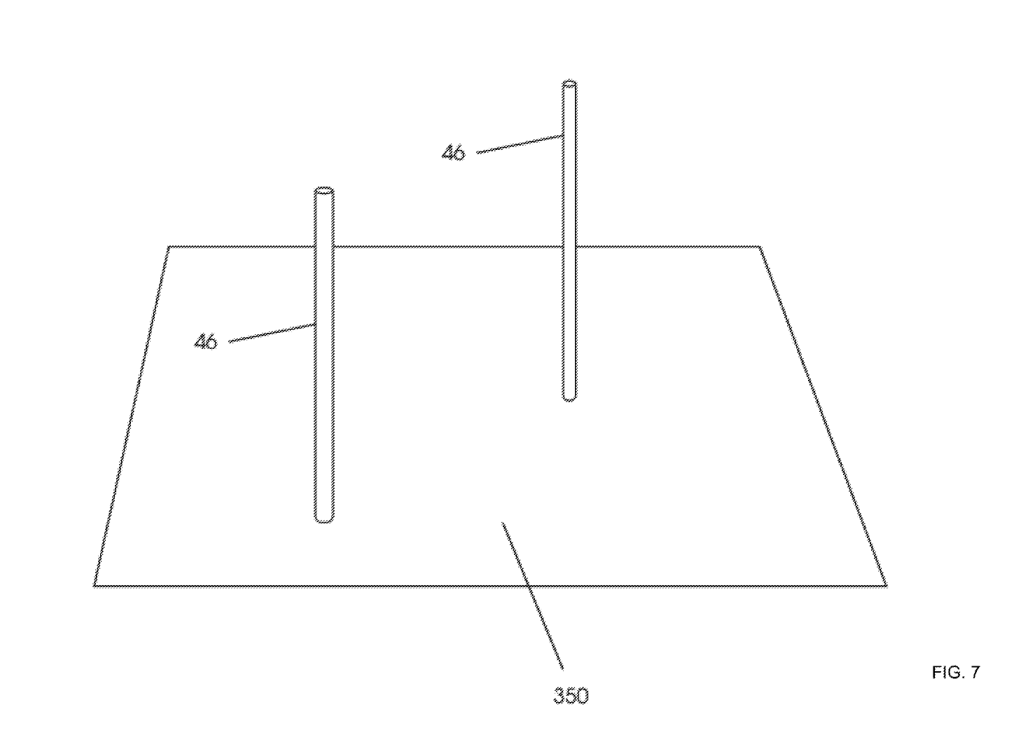

FIG. 8 is a perspective view of the side of the solar light yard sign system; the view showing the solar light yard sign system comprising a frame, upper panels, lower panels, a brochure box, among other components;

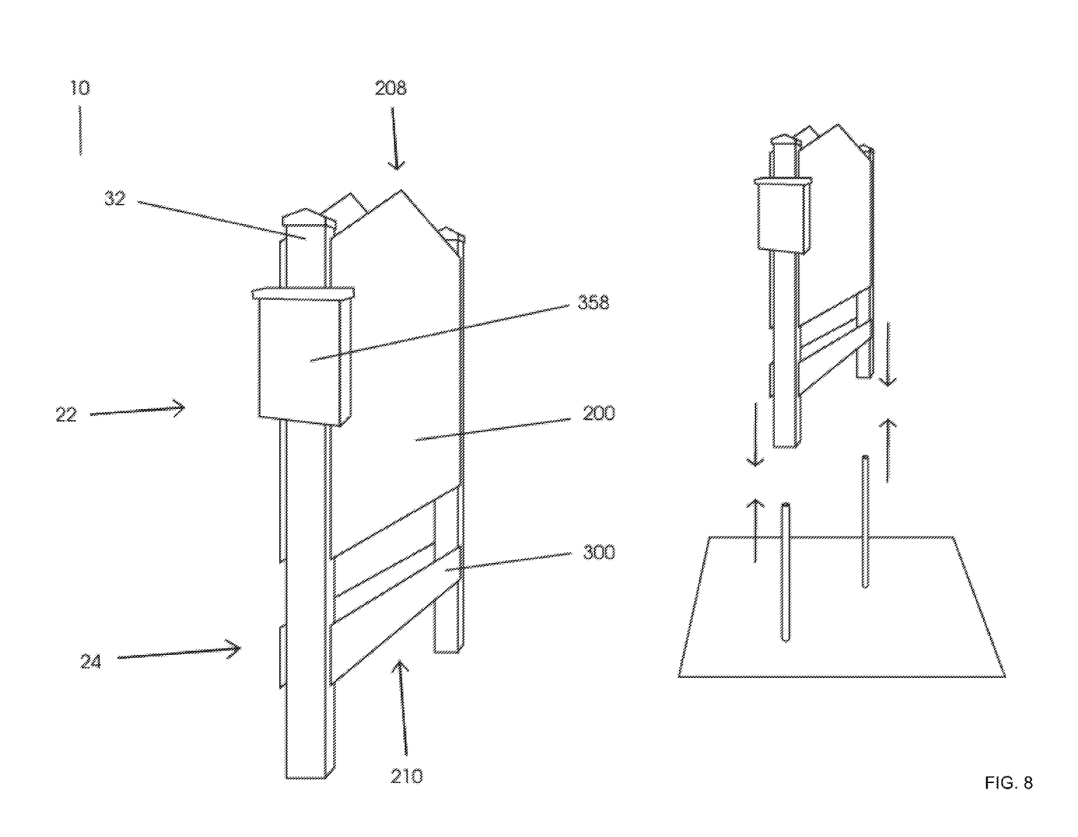

FIG. 9 is a perspective view of the front of the solar light yard sign system; the view showing the solar light yard sign system connected to a support by a mounting member.

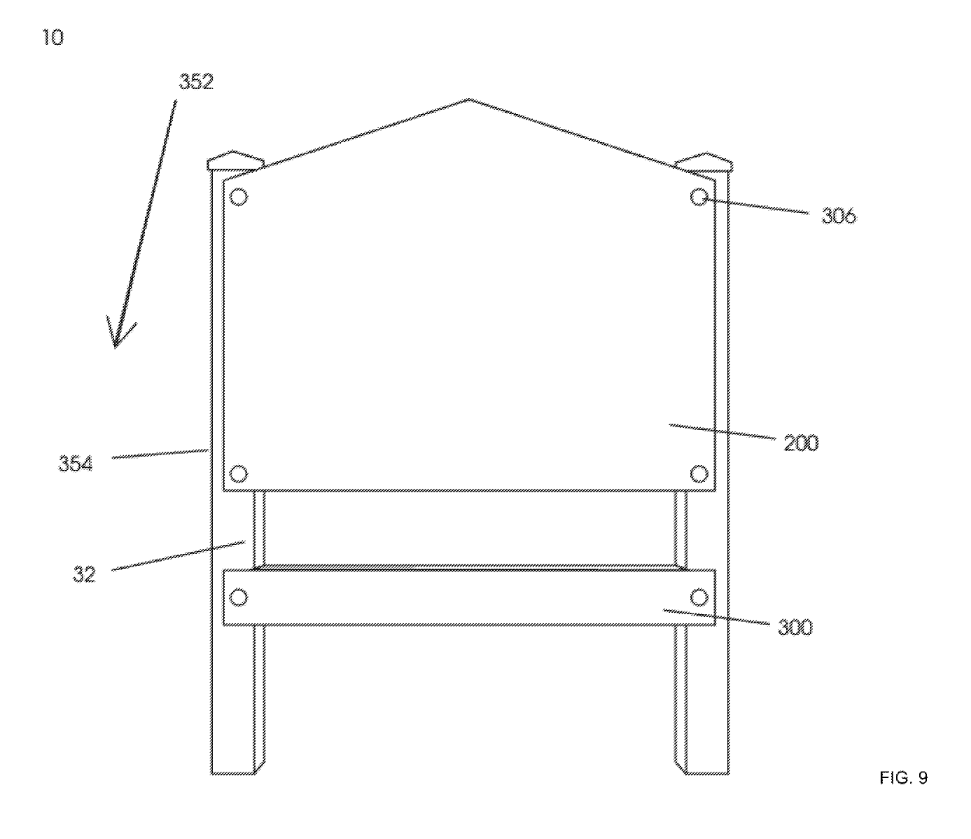

### DETAILED DESCRIPTION

In the following detailed description of the embodiments, reference is made to the accompanying drawings which form a part hereof, and in which is shown by way of illustration specific preferred embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the present disclosures. The following detailed description is, therefore, not to be taken in a limiting sense, and the scope of the present disclosure is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description, and are not intended to be used as limitations. Accordingly, orientation of an object or a combination of objects may change without departing from the scope of the disclosure.

System

In the arrangement shown, as one example, a solar light yard sign system 10 (or simply “system” 10) is formed of any suitable size, shape and design and is configured to be positioned upon a surface 350 or inserted into a surface 350, such as a yard, a lawn, a parking or curb area, or the like, and to be lit, when necessary, in order to provide information or advertising to passers-by during day time or night time hours. Alternatively, system 10 is formed of any suitable size, shape and design and is configured to hang from or connect to a support 352, such as, a building, a pole, posts, columns, or the like, where the system 10 is connected to a mounting member 354, such as a string, a cord, fasteners, brackets, screws, or the like, and to be lit, when necessary, in order to provide information or advertising to passers-by during day time or night time hours. In one arrangement, as one example, system 10 is configured to provide information or advertising to passers-by in a residential neighborhood and the system 10 is similar in size to a residential “for sale” sign. In another arrangement, as another example, system 10 is configured to provide information or advertising to passers-by in a commercial setting, along a roadway, etc. and the system 10 is similar in size to a billboard sign. However, the system 10 may be formed of any size which is suitable for its intended purpose and intended audience without departing from the scope of the disclosure.

In the arrangement shown, as one example, for purposes of clarity, the system 10 has a front 12, a back 14, and opposing sides 16. In the arrangement shown, as one example, system 10 is symmetrical, or generally symmetrical, or operatively symmetrical, and for this reason, unless specified otherwise, description of one side 16 of the system 10 shall apply to both sides 16 of the system 10 which is separated by an imaginary centerline that extends down the approximate top-to-bottom center of the system 10.

In the arrangement shown, as one example, the system 10 is formed of a frame 30, at least one panel 198, a light source 98, and a power source 106. Each element of the system 10 is discussed in detail below.

Frame

Frame 30 is formed of any suitable size, shape, and design and is configured to provide support to the system 10 and to facilitate system 10 to remain in an upright and usable position during use upon a surface 350, such as a yard, a lawn, a parking or curb area, or the like, or to be inserted into a surface 350, such as a yard, a lawn, a parking or curb area, or the like. Alternatively, frame 30 also facilitates connection of system 10 to a mounting member 354 which enables system 10 to remain durable and in a usable position during hanging from a support 352, such as a building, a gutter, an overhang of a building, an eave of a building, a pole, or the like. In one arrangement, frame 30 is formed of metal, steel, aluminum, wire, or plastic. However, frame 30 may be formed from any material without departing from the scope of the disclosure.

In the arrangement shown, as one example, frame 30 includes at least one post 32, a plurality of angle brackets 34, a plurality of screws 36, a top plate 40, and a bottom bar 42. Furthermore, in another arrangement, as one example, frame 30 includes a plurality of rods 38/56 in addition to other components. Posts 32 may be formed of any suitable size, shape, and design and are configured to provide support to the system 10 in order to facilitate the system 10 to remain in an upright and usable position. In the arrangement shown, as one example, post 32 extends in a straight and continuous manner. In one arrangement, post 32 is an elongated hollow tube which may be circular, square, or rectangular in shape. However, any other shape or configuration is hereby contemplated for use. In one arrangement, frame 30 includes two posts 32 wherein one post 32 is positioned on one side 16 of the system 10 and the other post 32 is positioned on the opposite side 16 of the system 10. However, frame 30 may include any number of posts 32. With that said, any other number of posts 32 is hereby contemplated for use by the disclosure, such as one, three, four, five, six, or more. In one arrangement, as shown, two posts 32 are positioned laterally adjacent to one another with a space positioned between them. This arrangement of two adjacent, yet spaced apart, posts 32 facilitates a strong and secure framework. Further, in one arrangement, as shown, posts 32 are formed of three (3) inch tube carbon steel pieces and the posts 32 are 48 inches long. However, as stated above, posts 32 may be formed of any material and posts 32 may be formed of any size of material without departing from the scope of the disclosure.

Top plate 40 may be formed of any suitable size, shape, and design and is configured to provide support to the system 10 in order to facilitate the system 10 to remain in a usable position. In the arrangement shown, as one example, top plate 40 extends in a straight and continuous manner. In one arrangement, as shown, top plate 40 is formed of a ⅛ inch piece of steel which is 34 inches (34″) long. However, top plate 40 may be formed of any size of material without departing from the scope of the disclosure. Further, top plate 40 may be formed of any material, such as metal, steel, aluminum, wire, plastic, or the like. In one arrangement, as shown, top plate 40 is positioned near the top 18 of the system 10 and in between the posts 32. In one arrangement, as shown, top plate 40 is welded together to posts 32 in order to strengthen the connection between top plate 40 and posts 32. Additionally, in one arrangement, as shown, angle brackets 34 are positioned underneath top plate 40 and to the side of posts 32 in order to strengthen the connection of top plate 40 and posts 32. Screws 36, such as tap screws 36, are utilized to connect angle brackets 34 to top plate 40 and posts 32. However, other forms of securing the connection between angle brackets 34 to top plate 40 and posts 32, such as glue, welding, tacks, and the like, may be utilized without departing from the scope of the disclosure.

Bottom bar 42 may be formed of any suitable size, shape, and design and is configured to provide support to the system 10 in order to facilitate the system 10 to remain in a usable position. In the arrangement shown, as one example, bottom bar 42 extends in a straight and continuous manner. In one arrangement, as one example, bottom bar 42 is an elongated hollow tube which may circular, square, or rectangular in shape. However, any other shape or configuration is hereby contemplated for use. In one arrangement, as an example, bottom bar 42 is formed of a piece of steel which is two inches (2″) in diameter and 34 inches (34″) long. However, bottom bar 42 may be formed of any size without departing from the scope of the disclosure. In one arrangement, as shown, bottom bar 42 is positioned near the bottom 20 of the system 10 and in between the posts 32. In one arrangement, frame 30 includes one bottom bar 42 wherein the bottom bar 42 is laterally adjacent to the top plate 40 with a space positioned between them. This arrangement of a top plate 40 and a bottom bar 42 adjacent to one another, yet spaced apart, facilitates a strong and secure framework. In one arrangement, as an example, frame 30 may include any number of bottom bars 42 without departing from the scope of the disclosure. In one arrangement, as one example, bottom bar 42 may be formed of any material, such as metal, steel, aluminum, wire, plastic, or the like. Bottom bar 42 may be formed of any material without departing from the scope of the disclosure. Additionally, bottom bar 42 is welded to the internal side of the posts 32 in order to strengthen the connection between bottom bar 42 and posts 32. Additionally, in one arrangement, as shown, angle brackets 34 are positioned on the top side of the bottom bar 42 and to the internal side of the posts 32 in order to strengthen the connection of bottom bar 42 and posts 32. Screws 36, such as tap screws 36, are utilized to connect angle brackets 34 to bottom bar 42 and posts 32. However, other forms of securing the connection between angle brackets 34 to bottom bar 42 and posts 32, such as glue, welding, tacks, and the like, may be utilized without departing from the scope of the disclosure.

Rods

In one arrangement, as one example, system 10 comprises rods 38/56. Rods 38/56 may be formed of any suitable size, shape, and design and are configured to provide support to the system 10 in order to facilitate the system 10 to remain in a usable position. Further, rods 38/56 are utilized to provide a member to securely connect a light source 98. In the arrangement, as shown, rods 38/56 extend in a straight and continuous manner. In one arrangement, as one example, rods 38/56 are circular, square, or rectangular in shape. However, any other shape or configuration is hereby contemplated for use. In one arrangement, as shown, rods 38/56 are positioned in the space between top plate 40 and bottom bar 42. Further, in one arrangement, rods 38/56 are positioned in the space between the posts 32 and top plate 40 and bottom bar 42. In one arrangement, system 10 includes two rods 38/56 wherein the rods 38/56 are laterally adjacent to one another with a space positioned between them. This arrangement of two rods 38/56 adjacent to one another, yet spaced apart, facilitates an evenly spaced distribution of light when the light source 98 is wrapped around the rods 38/56. However, system 10 may include any number of rods 38/56 without departing from the scope of the disclosure. In one arrangement, as one example, rods 38/56 may be formed of any material, such as metal, steel, aluminum, wire, plastic, or the like. Rods 38/56 may be formed of any material without departing from the scope of the disclosure. In one arrangement, as shown, the top end 48 of rods 38/56 is welded to the top plate 40 and the bottom end 50 of rods 38/56 is welded to the bottom bar 42. However, other forms of securing the connection between the top end 48 of the rods 38/56 with the top plate 40 and the bottom end 50 of the rods 38/56 with the bottom bar 42, such as glue, welding, tacks, and the like, may be utilized without departing from the scope of the disclosure.

Post Caps

In one arrangement, as shown, system 10 includes post caps 44. Post caps 44 may be formed of any suitable size, shape, and design and are configured to cap off the top end 52 of posts 32 to prevent injury on the exposed sharp edges of posts 32, to make the system 10 more aesthetically pleasing, and to prevent moisture, weather elements, and debris from entering the hollow interior of the posts 32. In the arrangement, as shown, post caps 44 mimic the shape and configuration of the posts 32 and the post caps 44 securely fit over the top end 52 of the posts 32. In one arrangement, as one example, post caps 44 are circular, shape, or rectangular in shape. However, any other shape or configuration is hereby contemplated for use. In one arrangement, as one example, post caps 44 are formed of a flexible plastic material. However, post caps 44 may be formed of any material, such as metal, steel, aluminum, plastic, silicone, or the like. For clarification, post caps 44 may be formed of any material without departing from the scope of the disclosure. In one arrangement, as one example, post caps 44 are securely connected to posts 32 by glue, adhesive, or the like. Post caps 44 may be securely connected to posts 32 by any mechanism or method by utilizing any material without departing from the scope of the disclosure. Alternatively, in one arrangement, as one example, post caps 44 may be connected to posts 32 simply by forming a tight connection with posts 32 as a result of being made of a flexible, adjustable material which can stretch and bend in order to encompass the post 32 and then securely attach to post 32 as a result of the friction between the post 32 and the post cap 44.

Light Source

Light source 98 is formed of any suitable size, shape, and design and is configured to illuminate the system 10 in order for the information displayed on the system 10 to be viewed by passers-by during night time hours. In one arrangement, light source 98 is formed of solar lights 100. However, light source 98 can be formed of any type of light such as an electrically powered light source 98, a battery powered light source 98, a solar powered light source 98, and the like. Any type of light source 98 may be utilized in the system 10 without departing from the scope of the disclosure. Additionally, any number of light sources 98 may be utilized in the system 10 without departing from the disclosure. In one arrangement, the light source 98 may comprise of one, two, three, four, five, six, seven, eight, nine, ten, or more lights 98. In one arrangement, the light source 98 comprises of a strand of lights 98. In another arrangement, the light source 98 is comprised of a plurality of solitaire lights 98.

Furthermore, light source 98 can be connected, secured, or affixed to the system 10 by any means without departing from the scope. In one arrangement, as described in more detail below, the light source 98 may be connected or secured to the system 10 by wrapping around a plurality of rods 38/56. In another arrangement, as described in more detail below, the light source 98 may be connected or secured to the system 10 by a bracket 112 which directly connects or secures the light source 98 to the frame 30.

In the arrangement shown, as one example, light source 98 is formed of solar lights 100 and a power source 106. Solar lights 100 may be formed of any suitable size, shape, and design. In one arrangement, as an example, the light source 98 is formed of upper panel solar lights 102. In another arrangement, as shown, the light source 98 is formed of upper panel solar lights 102 and bottom panel solar lights 104. In one arrangement, as an example, the upper panel solar lights 102 and the bottom panel solar lights 104 are formed of solar lights 100 connected to a wire, a cord, or the like 114 wherein the cord 114 is connected to a power source 106. The power source 106 supplies the lights 98 with energy to produce light in order to illuminate the system 10. In one arrangement, as shown, the power source 106 is formed of a solar charger 108 which comprises a solar panel 110. In one arrangement, as one example, solar charger 108 employs solar energy to supply electricity directly to the system 10 in order to illuminate the light source 98. In another arrangement, as one example, solar charger 108 employs solar energy to charge batteries which are placed within the solar charger 108 in order to provide electricity to the system 10.

In one arrangement, as an example, light source 98 is formed of upper panel solar lights 102 wherein upper panel solar lights 102 are formed of a strand of solar lights 100 connected to a wire, a cord, or the like 114 which is utilized in the upper section 22 of the system 10. In one arrangement, as one example, upper panel of solar lights 102 is wrapped around the rods 38/56. In one arrangement, as one example, the upper panel of solar lights 102 is wrapped around the first rod 38, extends in a straight and continuous manner across the length of the frame 30 to the second rod 56, then the upper panel of solar lights 102 is wrapped around the second rod 56, and then extends in a straight and continuous manner back across the length of the frame 30 to the first rod 38. This process is repeated for the entire length of the strand of upper panel of solar lights 102 in order to evenly distribute the source of light throughout the upper section 22 of the system 10.

In another arrangement, as shown, light source 98 is formed of upper panel solar lights 102 and bottom panel solar lights 104 wherein upper panel solar lights 102 are wrapped around the rods 38/56 in the upper section 22 of system 10 and bottom panel solar lights 104 are positioned in the lower section 24 of system 10. In one arrangement, as one example, upper panel solar lights 102 and bottom panel solar lights 104 are formed of solar lights 100, a solar charger 108 which includes a solar panel 110 wherein the solar charger 108 is positioned on top of the top plate 40 with the solar panel 110 facing upwards in order to expose the solar panel 110 to the available sunlight. In one arrangement, as one example, the upper panel of solar lights 102 are wrapped around the first rod 38, extend in a straight and continuous manner across the length of the frame 30 to the second rod 56, then the upper panel of solar lights 102 are wrapped around the second rod 56, and then extend in a straight and continuous manner back across the length of the frame 30 to the first rod 38. This process is repeated for the entire length of the strand of upper panel of solar lights 102 in order to evenly distribute the source of light throughout the upper section 22 of the system 10. In another arrangement, as shown, bottom panel solar lights 104 are securely connected to the lower panels 300. Bottom panel solar lights 104 may be connected to the lower panels 300 by any method such as, glue, tape, staples, being wrapped around rods, or the like, without departing from the scope of the disclosure. In one arrangement, as shown, bottom panel solar lights 104 are connected to at least one lower panel 300 by gluing the bottom panel solar lights 104 to at least one lower panel 300.

In another arrangement, as one example, light source 98 is formed of a solitary light and is secured or affixed to the frame 30 by a bracket 112. In this arrangement, the light source 98 may be formed of a singular solar light 100/102 which is secured or affixed to the frame 30 rather than being comprised of a strand of lights and being wrapped around rods 38/56. However, system 10 may comprise any number of lights 98 wherein the lights 98 are secured or affixed to the frame 30 by a bracket 112 without departing from the scope of the disclosure. Additionally, in an arrangement wherein the system 10 does not comprise rods 38/56, the lights 98 may be secured or affixed to the frame 30 by any means including, but not limited to, a bracket 112, glue, tape, hook and loop, etc. without departing from the scope of the disclosure. In one arrangement, the light source 98 comprises at least one light source for the upper panels 102 and, where applicable, at least one light source for the lower panels 104.

In another arrangement, as one example, light source 98 is formed of an external solar light wherein the external solar light is positioned on the surface 350 or inserted into the surface 350 and positioned in a direction towards the system 10 in order to illuminate the system 10. However, light source 98 may be formed of any type of light source 98, such as light sources 98 connected to an electrical socket, light sources 98 which are provided electricity by batteries, light sources 98 which are solar powered, LED lights, and the like, without departing from the scope of the disclosure.

Panels

Panels 198 are formed of any suitable size, shape, and design and are configured to provide support and functionality to system 10. Panels 198 include a display surface 206 which enables a user to display information, advertisements, and the like on the panels 198 to present the information to passers-by. Information, advertisements, and the like may be placed on the display surface 206 by a wide variety of means, such as a vinyl cling-on or sticker, stickers, printing, etching, painting, writing with a marker or other utensil, or the like without departing from the scope of the disclosure. In one arrangement, as one example, panels 198 are formed of plexi glass. However, panels 198 may be formed of any transparent material, such as glass, plexi glass, plastic, and the like, without departing from the scope of the disclosure. In one arrangement, as shown, panels 198 are formed with an angular cut at the top of the panels 198. The angular cut at the top of the panels 198 provides a larger display surface 206 which enables a user to place additional information on the panels 198. Additionally, the angular cut at the top of the panels 198 serves an aesthetic purposes as the angular cut at the top of the panels 198 serves to hide the solar charger 108 which may be placed on the top plate 40. Further, the angular cut at the top of the panels 198 causes the panels 198 to resemble the profile of a house which may be appealing to a user as a user may be utilizing the system 10 to place in the yard of a house which the user is selling. However, panels 198 may be formed of any shape, such as square, rectangular, circular, or the like, without departing from the scope of the disclosure. Additionally, panels 198 may be formed of any size and any material without departing from the scope of the disclosure.

In one arrangement shown, as one example, panels 198 include upper panels 200 wherein the upper panels 200 comprise a front upper panel 202 and a back upper panel 204. In one arrangement, upper panels 200 comprise a top end 208 and a bottom end 210. In one arrangement, as one example, upper panels 200 measure thirty-six inches (36″) tall by thirty-nine inches (39″) wide. Upper panels 200 may be formed of any size of material without departing from the scope of the disclosure. In one arrangement, as one example, upper panels 200 are formed of plexi-glass and upper panels 200 measure thirty-six inches (36″) tall by thirty-nine inches (39″) wide. However, upper panels 200 may be formed of any size and any material without departing from the scope of the disclosure. In one arrangement, as one example, the front upper panel 202 is connected to the posts 32 by screwing the front upper panel 202 to the posts 32 utilizing fasteners 306. In one arrangement, as one example, the front upper panel 202 is connected to the front 12 of the posts 32 at the top end 52 of the posts 32. In one arrangement, as shown, the back upper panel 204 is connected to the posts 32 by screwing the back upper panel 204 to the posts 32 utilizing fasteners 306. In one arrangement, as shown, the back upper panel 204 is connected to the back 14 of the posts 32 at the top end 52 of the posts 32. In one arrangement, as shown, lights 98/102 are positioned in between the front upper panel 202 and the back upper panel 204. While one arrangement comprises two upper panels 200, a front upper panel 202 and a back upper panel 204, any number of upper panels 200, such as one, two, three, four, or more may be utilized without departing from the scope of the disclosure. For clarity, any number of panels 198 may be utilized without departing from the scope of the disclosure. Additionally, fasteners 306 may be comprised of any type of screw, nail, connector, aluminum stand-off, or the like without departing from the scope of the disclosure.

In one arrangement shown, as one example, panels 198 include upper panels 200 and lower panels 300 wherein the upper panels 200 comprise a front upper panel 202 and a back upper panel 204 and the lower panels 300 include a front lower panel 302 and a back lower panel 304. In one arrangement shown, as one example, the front upper panel 202 is connected to the posts 32 by screwing the front upper panel 202 to the posts 32 utilizing fasteners 306. In one arrangement, as one example, the front upper panel 202 is connected to the front 12 of the posts 32. In one arrangement, as shown, the front upper panel 202 is connected to the front 12 of the top end 52 of the posts 32. In one arrangement, as shown, the back upper panel 204 is connected to the posts 32 by screwing the back upper panel 204 to the posts 32 utilizing fasteners 306. In one arrangement, as shown, the back upper panel 204 is connected to the back 14 of the posts 32. In one arrangement, as shown, the back upper panel 204 is connected to the back 14 of the top end 52 of the posts 32. In one arrangement, as shown, the front lower panel 302 is connected to the posts 32 by screwing the front lower panel 302 to the posts 32 utilizing fasteners 306. In one arrangement, as one example, the front lower panel 302 is connected to the front 12 of the posts 32. In one arrangement, as shown, the front lower panel 302 is connected to the front 12 of the bottom end 54 of the posts 32. In one arrangement, as shown, the back lower panel 304 is connected to the back 14 of the posts 32 at the bottom end 54 of the posts 32. In one arrangement, as shown, lights 98/104 are positioned in between the front lower panel 302 and the back lower panel 304. While one arrangement comprises two upper panels 200, a front upper panel 202 and a back upper panel 204, any number of upper panels 200, such as one, two, three, four, or more may be utilized without departing from the scope of the disclosure. While one arrangement comprises two lower panels 300, a front lower panel 302 and a back lower panel 304, any number of lower panels 300, such as one, two, three, four, or more may be utilized without departing from the scope of the disclosure. For clarity, any number of panels 198 may be utilized without departing from the scope of the disclosure.

Furthermore, panels 202/204/302/304 are secured to the frame 30 by fasteners 306. The fasteners 306 securely attach the panels 202/204/302/304 to the frame 30, but are easily unscrewed in order to easily remove the panels 202/204/302/304 in the event the lights 102/104 need to be replaced or a new design or display needs to be placed on the panels 202/204/302/304.

Pipe

In one arrangement, as one example, system 10 includes at least one pipe 46. Pipe 46 is formed of any suitable size, shape, and design and is configured to secure the system 10 to a surface 350. Any type of pipe 46 can be utilized in the system 10 without departing from the disclosure. Furthermore, any number of pipes 46 may be utilized in the system 10 without departing from the disclosure. For example, the system 10 may comprise one, two, three, four, five, six, seven, eight, nine, ten, or more pipes 46.

In one arrangement, as one example, system 10 includes one pipe 46 wherein a post 32 is placed over the top of the pipe 46. In an alternative arrangement, system 10 includes two posts 32 and two pipes 46 wherein the first post 32 is placed over the top of the first pipe 46 and the second post 32 is placed over the top of the second pipe 46. However, system 10 may include one, two, three, four, or more pipes 46 without departing from the scope of the disclosure. In one arrangement, as one example, pipe 46 is inserted into a surface 350, such as a yard, a lawn, a parking or curbing area, a dirt pile, a sand pile, or the like, and a post 32 is placed over the top of pipe 46 in order to securely connect system 10 to the surface 350.

In one arrangement, as one example, pipe 46 is formed of metal, steel, aluminum, plastic, PVC, wood, or the like. Pipe 46 may be formed of any material without departing from the scope of the disclosure. In one arrangement, pipe 46 is formed of a one inch (1″) metal pipe 46 wherein the pipe 46 is circular in shape. However, pipe 46 may be formed of any size, shape, or design without departing from the scope of the disclosure.

GPS Tracker

In one arrangement, as one example, system 10 further comprises a GPS tracker 356. GPS tracker 356 may be formed of any suitable size, shape, and design and is configured to provide the ability to determine the precise location of system 10. In one arrangement, as one example, GPS tracker 356 may be positioned internally in system 10. In one arrangement, as one example, GPS tracker 356 may be positioned on the bottom 20 of system 10. However, GPS tracker 356 may be positioned on or in any location within system 10 without departing from the scope of the disclosure. Furthermore, any type of GPS tracker 356, such as data loggers, data pushers, GPS beacon, and the like, may be utilized without departing from the scope of the disclosure.

Brochure Box

In one arrangement, as shown, the system 10 further comprises a brochure box 358. Brochure box 358 may be formed of any suitable size, shape, and design and is configured to provide brochures, fliers, printed materials, and the like to passers-by. In one arrangement, as shown, brochure box 358 is connected to the frame 30. However, brochure box 358 can be attached to any location on system 10 without departing from the scope of the disclosure. Furthermore, brochure box 358 can be connected to system 10 by any means such as, screws, glue, double-sided tape, or any other form of connector without departing from the scope of the disclosure.

In Operation

In one arrangement, system 10 is positioned in an upright manner, wherein the system 10 comprises a frame 30 comprising two posts 32 and a plurality of rods 38/56, a front upper panel 202, a back upper panel 204, upper panel solar lights 102, a solar charger 108, a solar panel 110, a plurality of pipes 46, among other elements. In this position, the pipes 46 are inserted into a surface 350. Then the first post 32 is placed over the first pipe 46 and the second post 32 is placed over the second pipe 46 to securely connect the system 10 to the surface 350 in order to prevent the system 10 from being blown away due to high winds, weather elements, and the like. Further, the upper panel solar lights 102 are positioned within the front upper panel 202 and the back upper panel 204. Further, information and advertisements can be displayed on the upper panels 200. The information and advertisements can be viewed by passers-by during daytime hours and during night time hours as a result of the upper panels 200 being illuminated by the upper panel solar lights 102. Furthermore, the panels 202/204 are secured to the frame 30 by fasteners 306. The fasteners 306 securely attach the panels 202/204 to the frame 30, but are easily unscrewed in order to easily remove the panels 202/204 in the event the lights 102 need to be replaced or a new design or display needs to be placed on the panels 202/204.

In one arrangement, as is shown, system 10 is positioned in an upright manner, wherein the system 10 comprises a frame 30 comprising two posts 32 and a plurality of rods 38/56, a front upper panel 202, a back upper panel 204, a front lower panel 302, a back lower panel 304, upper panel solar lights 102, bottom panel solar lights 104, a solar charger 108, a solar panel 110, a plurality of pipes 46, among other elements. In this position, the pipes 46 are inserted into a surface 350. Then the first post 32 is placed over the first pipe 46 and the second post 32 is placed over the second pipe 46 to securely connect the system 10 to the surface 350 in order to prevent the system 10 from being blown away due to high winds, weather elements, and the like. Further, the upper panel solar lights 102 are positioned within the front upper panel 202 and the back upper panel 204 and the bottom panel solar lights 104 are positioned in between the front lower panel 302 and the back lower panel 304. Further, information and advertisements can be displayed on the upper panels 200 and the lower panels 300. The information and advertisements can be viewed by passers-by during daytime hours and during night time hours as a result of the upper panels 200 and the lower panels 300 being illuminated by the upper panel solar lights 102 and the bottom panel solar lights 104 respectively. Furthermore, the panels 202/204/302/304 are secured to the frame 30 by fasteners 306. The fasteners 306 securely attach the panels 202/204/302/304 to the frame 30, but are easily unscrewed in order to easily remove the panels 202/204/302/304 in the event the lights 102/104 need to be replaced or a new design or display needs to be placed on the panels 202/204/302/304.

In one arrangement, as shown, system 10 is positioned in an upright manner, wherein the system 10 comprises a frame 30, a plurality of posts 32, a front upper panel 202, a back upper panel 204, at least one light 98 secured or affixed to the frame 30, among other components. In one arrangement, the at least one light 98 is formed of a plurality of solitaire solar lights 100. In one arrangement, as shown, the at least one light 98/100/102 is secured to the frame 30 in between the upper panels 200. In another arrangement, as shown, the system 10 further comprises lower panels 300 wherein there is a front lower panel 302 and a back lower panel 304 and there is at least one light 98/100/102 secured to the frame 30 between the upper panels 200 and at least one light 98/100/104 secured to the frame 30 between the lower panels 300. In one arrangement, as is shown, system 10 is positioned in an upright manner, wherein the system 10 comprises a frame 30 comprising of two posts 32 and at least a front upper panel 202, among other elements. In this arrangement, system 10 is positioned upon a surface 350 or inserted into a surface 350 and the light source 98 is comprised of an external solar light 98 which is positioned upon the surface 350 or inserted into the surface 350. Furthermore, the external solar light 98 is positioned in a direction towards the system 10 and the external solar light 98 illuminates the system 10 in order for information and/or advertisements displayed on the upper panels 200/202 to be viewed by passers-by during daytime hours and during night time hours.

What is claimed:

1. A solar light yard sign system comprising:
A frame wherein the frame is formed of at least one post, a top plate, and a bottom bar;
At least one light source;
At least one panel; and
A power source.

2. The solar light yard sign system of claim 1 wherein the light source is a plurality of solar lights.

3. The solar light yard sign system of claim 1 wherein the at least one panel comprises a plurality of upper panels.

4. The solar light yard sign system of claim 1 further comprising:
Wherein the at least one panel comprises a plurality of upper panels;
Wherein the plurality of upper panels comprises a top end and a bottom end; and
Wherein the top end of the upper panels are formed with an angular cut.

5. The solar light yard sign system of claim 1 wherein the at least one panel comprises a plurality of upper panels and a plurality of lower panels.

6. The solar light yard sign system of claim 1 further comprising:
A plurality of rods;
Wherein the at least one light source is a plurality of solar lights;
Wherein the plurality of solar lights are wrapped around the plurality of rods.

7. The solar light yard sign system of claim 1 further comprising:
A plurality of rods;
Wherein the at least one panel is comprised of a plurality of upper panels;
Wherein the at least one light source is comprised of a plurality of solar lights which extend a length;
Wherein the plurality of rods contains a first rod and a second rod; and
Wherein the plurality of solar lights are positioned in between the plurality of upper panels, and wherein the plurality of solar lights are wrapped around the first rod, extend in a straight and continuous manner across the length of the frame to the second rod, are wrapped around the second rod, and then extend across the length of the frame back to the first rod, and wherein this process is repeated for the length of the plurality of solar lights.

8. The solar light yard sign system of claim 1 further comprising:
At least one pipe;
Wherein the at least one pipe is inserted in a surface and extends a length upward from the surface;
Wherein the portion of the at least one pipe extending upward from the surface is inserted within the at least one post in order to secure the solar light yard sign system to the surface.

9. The solar light yard sign system of claim 1 further comprising a brochure box.

10. The solar light yard sign system of claim 1 wherein the light source is an external solar light.

11. The solar light yard sign system of claim 1 wherein the at least one light source is a solar light connected to the frame.

12. The solar light yard sign system of claim 1 further comprising:
At least one pipe;
Wherein the at least one light source is a solar light connected to the frame;
Wherein the at least one pipe is inserted in a surface and extends a length upward from the surface;
Wherein the portion of the at least one pipe extending upward from the surface is inserted within the at least one post in order to secure the solar light yard sign system to the surface.

13. A solar light yard sign system comprising:
A frame extending a length;
The frame comprising two posts, a first rod, a second rod, a top plate, and a bottom bar;
A light source wherein the light source is comprised of upper panel solar lights and bottom panel solar lights;
A solar charger;
A solar panel;
Upper panels wherein the upper panels are comprised of a front upper panel and a back upper panel;
Lower panels wherein the lower panels are comprised of a front lower panel and a back lower panel;
Wherein the upper panel solar lights are positioned in between the front upper panel and the back upper panel;
Wherein the bottom panel solar lights are positioned in between the front lower panel and the back lower panel;
Wherein the upper panel solar lights are wrapped around the first rod extending in a straight and continuous manner across the length of the frame to the second rod, wrapped around the second rod and then extending in a straight and continuous manner across the length of the frame to the first rod.

14. The solar light yard sign system of claim 13 further comprising:
At least one pipe;
Wherein the at least one pipe is inserted into a surface and extends a length upward from the surface;
Wherein the portion of the at least one pipe extending upward from the surface is inserted within the at least one post in order to secure the solar light yard sign system to the surface.

15. The solar light yard sign system of claim 13, further comprising a brochure box.
